(19) United States
(12) Patent Application Publication
(10) Pub. No.: US 2013/0157099 A1
(43) Pub. Date: Jun. 20, 2013

(54) PROPULSION BATTERY WITH PRE-MANUFACTURED STRUCTURAL HEAT EXCHANGER

(71) Applicant: Alastair Gordon Anderson, Wiesbaden (DE)

(72) Inventor: Alastair Gordon Anderson, Wiesbaden (DE)

(73) Assignee: GM GLOBAL TECHNOLOGY OPERATIONS LLC, Detroit, MI (US)

(21) Appl. No.: 13/325,718

(22) Filed: Dec. 14, 2011

(51) Int. Cl. H01M 10/50; B23P 11/00; H01M 10/02

(52) U.S. Cl. 429/120; 429/159; 29/428

(57) ABSTRACT

A frame assembly for a battery package includes a frame body and a pair of frame covers. The frame body has a first recess, a second recess, and a central aperture. The central aperture is disposed between the first recess and the second recess. The first recess is configured to receive a first battery cell. The second recess is configured to receive a second battery cell. The central aperture is configured to receive an expansion unit. Each of the frame covers is disposed adjacent one of the first recess and the second recess. The frame covers hold the first battery cell, the second battery cell, and the expansion unit within the frame body.

### FIELD OF THE INVENTION

The present disclosure relates to a battery pack and more particularly to a heat exchanger for the battery pack.

### BACKGROUND OF THE INVENTION

A battery cell has been proposed as a clean, efficient and environmentally responsible power source for electric vehicles and various other applications. One type of battery cell is known as the lithium-ion battery. The lithium-ion battery is rechargeable and can be formed into a wide variety of shapes and sizes so as to efficiently fill available space in electric vehicles. For example, the battery cell may be prismatic in shape to facilitate a stacking of the battery cells. A plurality of individual battery cells can be provided in a battery pack to provide an amount of power sufficient to operate electric vehicles.

Typical prismatic battery cells have a pair of plastic coated metal layers fused around a periphery of the battery cell in order to seal the battery cell components. The sealing of the battery cells generally begins with providing one of the plastic coated metal layers with a cavity, sometimes called a “butter dish” shape. The battery cell components are disposed inside the cavity of the plastic coated metal layer. The other of the plastic coated metal layers is then placed on top of the battery cell components and fused at the periphery to the one of the plastic coated metal layers with the cavity, for example, by heat sealing around the edges. The battery cell for incorporation in the battery pack is thereby provided.

In operation and during a charge cycle, battery cells such as lithium-ion battery cells experience an increase in temperature, and have required heat exchanger cooling systems. A known method for cooling battery cells is to bring the battery cells into face contact with cooling fins, through which a coolant flows. The cooling fins are generally connected by two flexible metal bellow components, forming the inlet and outlet headers for the coolant. The cooling fins and the bellows may be connected by brazing or an alternative method. When the battery cells are inserted between the cooling fins, the bellows must be extended to increase the cooling fin offset. Once the battery cells have been positioned between the cooling fins, the radiator assembly must be compressed together to push the cooling fins into contact with the battery cells.

There is a continuing need for a simplified heat exchanger assembly to replace the known flexible bellow-radiator, which is difficult to handle and position. Desirably, the simplified heat exchanger assembly also minimizes a complexity of manufacturing a battery pack with the heat exchanger assembly.

### SUMMARY OF THE INVENTION

In concordance with the instant disclosure, a simplified heat exchanger assembly to replace the known flexible bellow-radiator, which is difficult to handle and position, and which minimizes a complexity of manufacturing a battery pack with the heat exchanger assembly, is surprisingly discovered.

In one embodiment, a frame assembly for a battery cell package includes a frame body and a pair of frame covers. The frame body has a first recess, a second recess, and a central aperture. The central aperture is disposed between the first recess and the second recess. The first recess is configured to receive a first battery cell. The second recess is configured to receive a second battery cell. The central aperture is configured to receive an expansion unit. Each of the frame covers is disposed adjacent one of the first recess and the second recess for holding the first battery cell, the second battery cell, and the expansion unit within the frame body.

In another embodiment, a battery package includes a first battery cell and a second battery cell, and an expansion unit disposed between the first battery cell and the second battery cell. The battery package also includes a frame assembly including a frame body and a pair of frame covers. The frame body has a first recess, a second recess, and a central aperture. The central aperture is disposed between the first recess and the second recess. The first recess receives the first battery cell. The second recess receives the second battery cell. The central aperture receives the expansion unit. Each of the frame covers is disposed adjacent one of the first recess and the second recess. The frame covers hold the first battery cell, the second battery cell, and the expansion unit within the frame body.

In a further embodiment, a battery pack includes a plurality of battery packages. Each of the battery packages includes a first battery cell and a second battery cell, and an expansion unit. The expansion unit is disposed between the first battery cell and the second battery cell. Each of the battery packages also includes a frame assembly having a frame body and a pair of frame covers. The frame body has a first recess, a second recess, and a central aperture. The central aperture is disposed between the first recess and the second recess. The first recess receives the first battery cell. The second recess receives the second battery cell. The central aperture receives the expansion unit. Each of the frame covers is disposed adjacent one of the first recess and the second recess to hold the first battery cell, the second battery cell, and the expansion unit within the frame body. The battery pack also includes a heat exchanger. The heat exchanger has a plurality of cooling fins. At least one of the cooling fins is disposed between a pair of the plurality of battery packages.

In an additional embodiment, a method for manufacturing a battery pack includes the steps of stacking a plurality of battery packages, each of the battery packages including a first battery cell and a second battery cell, an expansion unit disposed between the first battery cell and the second battery cell, and a frame assembly including a frame body and a pair of frame covers, the frame body having a first recess, a second recess, and a central aperture disposed between the first recess and the second recess, the first recess receiving the first battery cell, the second recess receiving the second battery cell, and the central aperture receiving the expansion unit, each of the frame covers disposed adjacent one of the first recess and the second recess to hold the first battery cell, the second battery cell, and the expansion unit within the frame body; and inserting the plurality of battery packages into a heat exchanger having a plurality of cooling fins, wherein at least one of the cooling fins is disposed between a pair of the plurality of battery packages.

### DRAWINGS

The above, as well as other advantages of the present disclosure, will become readily apparent to those skilled in the art from the following detailed description, particularly when considered in the light of the drawings described herein.

FIG. 1 is an exploded side perspective view of a frame assembly including a frame body and a pair of frame covers for a battery package;

FIG. 2 is a partially exploded side perspective view of a battery stack assembly including a plurality of battery packages and a heat exchanger, each of the battery packages having a frame assembly as shown in FIG. 1;

FIG. 3 is a fragmentary partially exploded cross-sectional side elevational view of the battery stack assembly taken along section line A-A in FIG. 2, with the heat exchanger partially shown to illustrate cooling fins of the heat exchanger for cooperation with the battery packages; and

FIG. 4 is a fragmentary cross-sectional side elevational view of the battery pack assembly including the battery packages and the heat exchanger illustrated in FIG. 3, the cooling fins of the heat exchanger cooperating with the battery packages.

### DETAILED DESCRIPTION OF THE INVENTION

The following detailed description and appended drawings describe and illustrate various embodiments of the invention. The description and drawings serve to enable one skilled in the art to make and use the invention, and are not intended to limit the scope of the invention in any manner. In respect of the methods disclosed, the steps presented are exemplary in nature, and thus, are not necessary or critical.

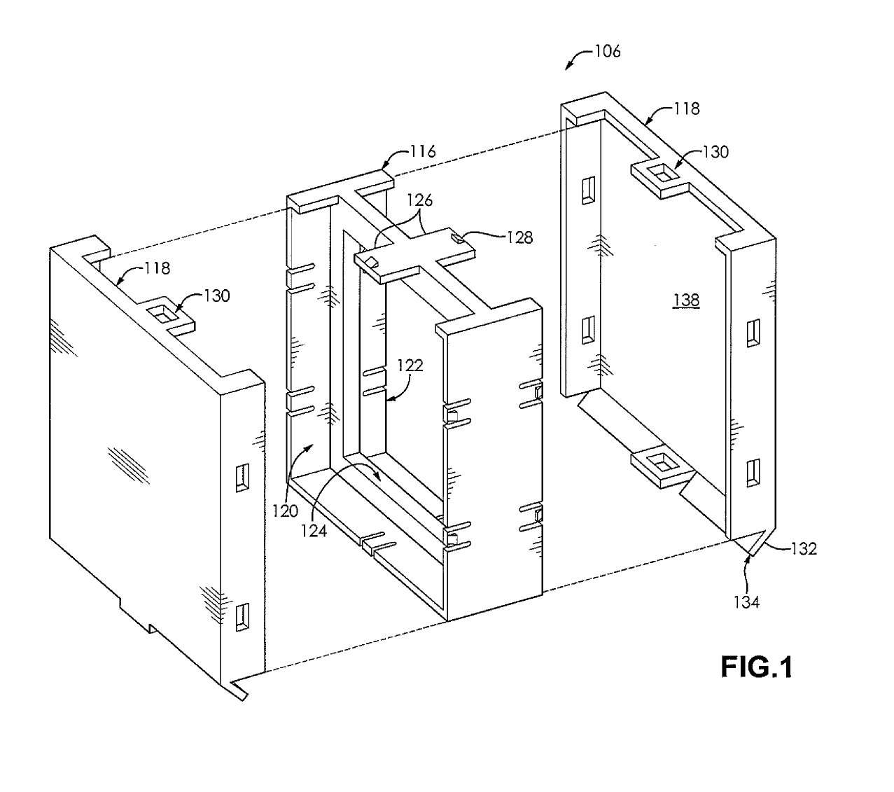

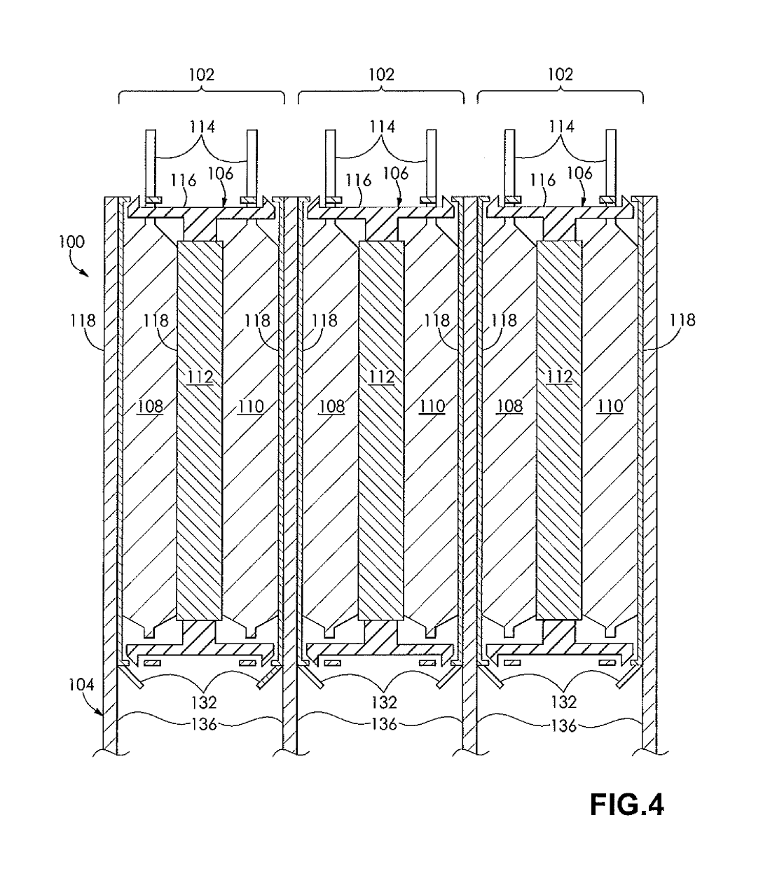

With reference to FIGS. 1-4, battery pack assembly 100 having a plurality of battery packages 102 and a heat exchanger 104 is shown. Each of the battery packages 102 includes a frame assembly 106, a first battery cell 108 and a second battery cell 110. An expansion unit 112 is disposed between the first battery cell 108 and the second battery cell 110 to compensate for variation in thicknesses of the first battery cell 108 and the second battery cell 110, as well as expansion of the first and second battery cells 108, 110 during operation. Each of the first battery cell 108, the second battery cell 110, and the expansion unit 112 is held and protected by the frame assembly 106. The battery packages 102 are disposed in a stack and inserted into the heat exchanger 104 to form the battery pack assembly 100.

The heat exchanger 104 of the present disclosure may be manufactured as a substantially rigid body. For example, the heat exchanger 104 may be a radiator with pipes (not shown) connected to cooling fins 136. The cooling fins 136 may have at least one conduit formed therein, through which a coolant is circulated from the pipes connected thereto. In other embodiments, the cooling fins 136 conduct heat from the battery packages 102 and transfer the heat to the coolant in the pipes. Advantageously, no bellows or expansion and contraction of the heat exchanger 104 is necessary with the battery pack assembly 100 of the present disclosure.

The first and second battery cells 108, 110 are configured to generate power from an electrochemical reaction. The first and second battery cells 108, 110 may each be a prismatic battery cell, for example, as described and shown in Assignee's co-pending U.S. patent application Ser. No. 13/035,236 to Heise. As a nonlimiting example, each of the first and second battery cells 108, 110 is a prismatic lithium ion (Li-ion) pouch cell having electrical tabs 114 for placing the first and second battery cells 108, 110 in electrical communication with a load such as an electric vehicle. The expansion unit 112 may be a polymeric foam layer that permits an expansion and contraction of the first and second battery cells 108, 110 during operation. It should be appreciated that other types of the first and second battery cells 108, 110, employing a different structure and electrochemistry, and other types of expansion units 112, may also be used within the scope of the present invention.

As shown in FIG. 1, the frame assembly 106 includes a frame body 116 and a pair of frame covers 118 configured to hold and position each of the battery cells 108, 110 within the frame body 116. The frame body 116 has a first recess 120 for receiving the first battery cell 108, and a second recess 122 for receiving the second battery cell 110. The main body 116 also has a central aperture 124 configured to receive the expansion unit 112. The central aperture 124 positions the expansion unit 112 between the first battery cell 108 and the second battery cell 110.

Each of the frame covers 118 is disposed adjacent one of the first recess 120 and the second recess 122 for positioning the first battery cell 108, the second battery cell 110, and the expansion unit 112 within the frame body 116. The frame covers 118 may slide over the frame body 116, for example. In certain embodiments, the frame body 116 may have a plurality of tabs 126 configured to cooperate with the frame covers 118 to secure the frame covers 118 to the frame body 116. In a particular embodiment, each of the tabs 126 has a detent 128 formed thereon that is received by a corresponding notch 130 in each of the frame covers 118. Other suitable means for securing the frame covers 118 to the frame body 116 may also be used within the scope of the present disclosure.

It should understood that the frame covers 118, in addition to protecting the outside surfaces of the battery cells 106, 108 and holding the battery cells 106, 108 and expansion unit 112 in position in the vertical and lateral directions, also allow a limited movement in a stacking direction.

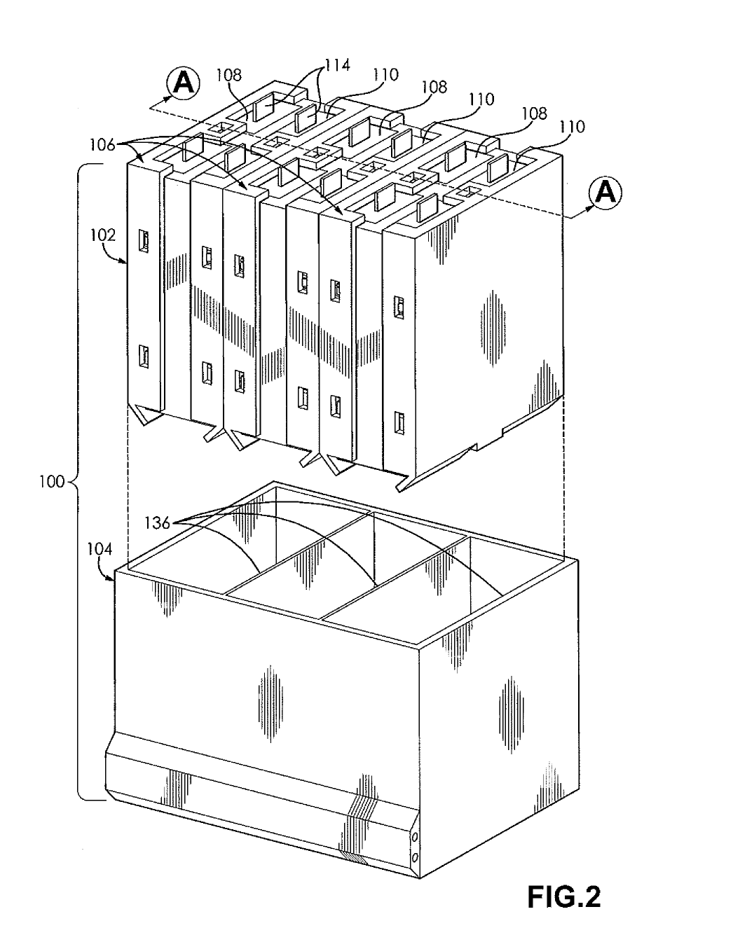

The frame covers 118 may further have lead-in panels 132 disposed at one end 134 of the frame covers 118. The lead-in panels 132 provide a chamfered surface for guiding cooling fins 136 (shown in FIGS. 2-4) of the heat exchanger 104 adjacent the frame covers 118. For example, where each of the frame covers 118 has a primary wall 138, and each of the lead-in panels 132 is coupled to one of the primary walls 138, the lead-in panel 132 may be orientated at an angle relative to an orientation of the primary wall 138 to provide the chamfered surface. Advantageously, the lead-in panels 132 ensure that the cooling fins 136 are correctly inserted between battery packages 102 during manufacturing of the battery pack assembly 100.

The frame body 116 and the frame covers 118 of the frame assembly 106 may be formed from the same or different materials, as desired. In an illustrative embodiment, the frame body 116 is formed from a dielectric polymer such as plastic, and the frame covers 118 are formed from a metal such as aluminum. Where the frame covers 118 are formed from the metal or another electrically conductive material, a surface of each of the frame covers 118 that will contact one of the first and second battery cells 108, 110 may be covered with a low-friction, dielectric coating. As a nonlimiting example, the low-friction, dielectric coating is a plastic foil. The low-friction, dielectric coating permits a lower insertion force upon insertion of the battery packages 102 into the heat exchanger 104, while also adding an additional electrical isolation between the battery packages and the heat exchanger 104. One of ordinary skill in the art may select other suitable materials for the frame body 116, the frame covers 118, and the coatings, as desired.

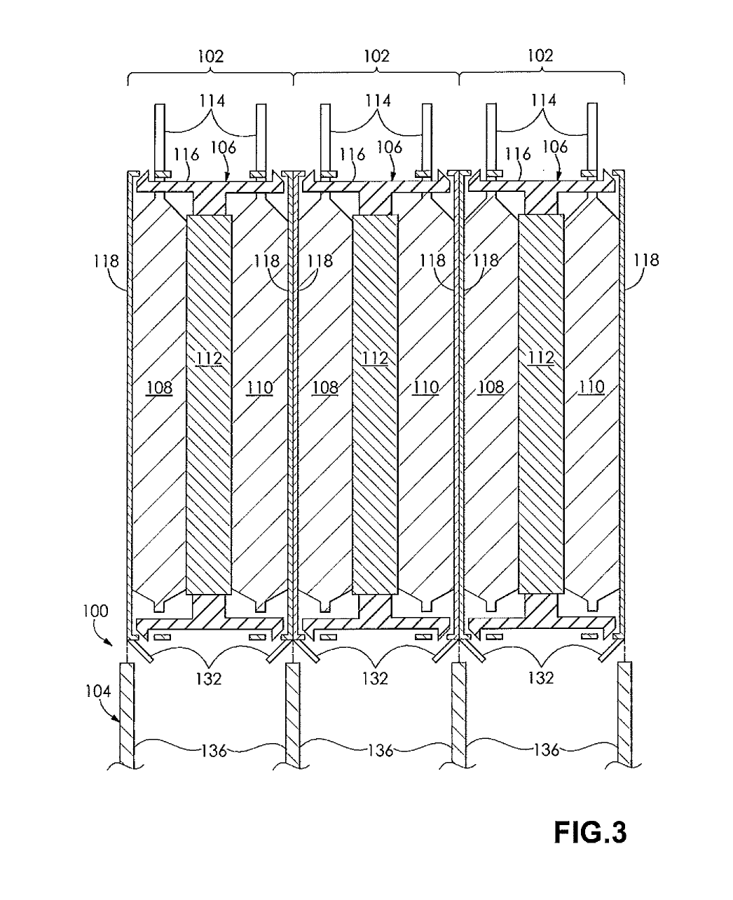

The present disclosure further includes a method for manufacturing the battery pack assembly 100, for example, as shown in FIGS. 2-4. Following an assembly of each of the battery packages 102 as described hereinabove, the method includes a step of stacking the plurality of battery packages 102. The stacked battery packages 102 may also be compressed together to substantially a same overall length as the heat exchanger 104 into which the stack of battery packages 102 is to be disposed. The stack of battery packages 102 is then positioned next to the heat exchanger 104, for example, as shown in FIGS. 2-3. Although only three battery packages 102 are illustrated, it should be appreciated that many more of the battery packages 102 may also be disposed in the stack, as desired.

After the battery packages 102 have been stacked and, if necessary, compressed to the desired length, the plurality of battery packages 102 is inserted into the heat exchanger 104. It should be appreciated that the heat exchanger 104 may be used as a stop to define a compressed length of the stack of battery packages 102 in operation.

As shown in FIGS. 2-4, the heat exchanger 104 has the plurality of cooling fins 136. Due to the insertion of the battery packages 102 into the heat exchanger 104, at least one of the plurality of cooling fins 136 is disposed between a pair of the plurality of battery packages 102. Surfaces of the individual battery cells 108, 110 within the battery packages 102 are protected by the frame covers 118 of the frame assembly 106 holding the individual battery cells 108, 110.

It should be appreciated that the lead-in panels 132 may advantageously facilitate a guidance of the cooling fins 136 between the pairs of battery packages 102 during the insertion step. Likewise, a presence of a low-friction coating on the frame covers 118 may also facilitate a sliding of the cooling fins 136 between the pairs of battery packages 102 during insertion of the battery packages 102 into the heat exchanger 104.

Advantageously, the battery pack assembly 100 of the present disclosure, including the plurality of battery packages 102 with the frame assemblies 106, simplifies a manufacturing of the battery pack assembly 100. In particular, a flexible bellow-radiator as known in the art, and which is difficult to handle and position, is not necessary with the battery pack assembly 100. Since bellows components are not employed with the heat exchanger 104, a complexity of manufacturing and handling, for example, during brazing procedures, is minimized. Furthermore, all heat exchanger 104 components can be manufactured from one metal type, for example, aluminum, with the battery pack assembly 100 of the disclosure.

As the heat exchanger 104 may be formed as a rigid body, it should be further appreciated that the heat exchanger 104 may be employed as a structural component of the battery pack assembly 100. For example, the rigid heat exchanger 104 may define the length of the manufactured battery pack assembly 100. As a further example, end plates (not shown) may be integral with the heat exchanger 104, or may be separately inserted into the heat exchanger 104 with the stack of battery packages 102, as desired.

The battery pack assembly 100 of the disclosure further simplifies a stacking of the individual battery packages 102 prior to insertion into the heat exchanger 104, by militating against a need to hold individual ones of the battery packages 102 apart during the insertion process.

It should also be appreciated that the frame covers 118 of the frame assembly 106 may also be employed to spread a compression pressure overall an entirety of facing surfaces of the first and second battery cells 108, 110. A durability of the first and second battery cells 108, 110 may thereby be enhanced with the battery cell assembly 100.

While certain representative embodiments and details have been shown for purposes of illustrating the invention, it will be apparent to those skilled in the art that various changes may be made without departing from the scope of the disclosure, which is further described in the following appended claims.

What is claimed is:

1. A frame assembly for a battery package, comprising:
a frame body having a first recess, a second recess, and a central aperture disposed between the first recess and the second recess, the first recess configured to receive a first battery cell, the second recess configured to receive a second battery cell, and the central aperture configured to receive an expansion unit; and
a pair of frame covers, each of the frame covers disposed adjacent one of the first recess and the second recess for holding the first battery cell, the second battery cell, and the expansion unit within the frame body.

2. The frame assembly of claim 1, wherein the frame body has a plurality of tabs, each of the tabs having a detent formed thereon.

3. The frame assembly of claim 2, wherein each of the frame covers has a notch that receives the detent of one of the plurality of tabs of the frame body to secure the frame covers to the frame body.

4. The frame assembly of claim 1, wherein each of the frame covers includes a lead-in panel disposed at one end thereof, the lead-in panels configured to guide cooling fins of a heat exchanger adjacent the frame covers.

5. The frame assembly of claim 4, wherein each of the frame covers includes a primary wall, and each of the lead-in panels is coupled to the primary wall.

6. The frame assembly of claim 5, wherein each of the lead-in panels is orientated at an angle relative to an orientation of the primary wall to which the lead-in panel is coupled.

7. The frame assembly of claim 1, wherein the frame body is formed from a dielectric polymer.

8. The frame assembly of claim 7, wherein the frame covers are formed from a metal.

9. The frame assembly of claim 8, wherein a surface of each of the frame covers is coated with a low-friction material.

10. A battery package, comprising:
a first battery cell and a second battery cell;
an expansion unit disposed between the first battery cell and the second battery cell;
and a frame assembly including a frame body and a pair of frame covers, the frame body having a first recess, a second recess, and a central aperture disposed between the first recess and the second recess, the first recess receiving the first battery cell, the second recess receiving the second battery cell, and the central aperture receiving the expansion unit, each of the frame covers disposed adjacent one of the first recess and the second recess to hold the first battery cell, the second battery cell, and the expansion unit within the frame body.

11. The battery package of claim 10, wherein the frame body has a plurality of tabs, each of the tabs having a detent formed thereon.

12. The battery package of claim 11, wherein each of the frame covers has a notch that receives the detent of one of the plurality of tabs of the frame body to secure the frame covers to the frame body.

13. The battery package of claim 10, wherein each of the frame covers has a lead-in panel disposed at one end of the frame covers, the lead-in panels configured to guide cooling fins of a heat exchanger adjacent the frame covers.

14. The battery package of claim 13, wherein each of the frame covers has a primary wall, and each of the lead-in panels is coupled to primary wall.

15. The battery package of claim 14, wherein each of the lead-in panels is orientated at an angle relative to an orientation of the primary wall to which the lead-in panel is coupled.

16. The battery package of claim 10, wherein the frame body is formed from a dielectric polymer.

17. The battery package of claim 16, wherein the frame covers are formed from a metal.

18. A battery pack assembly, comprising;
a plurality of battery packages, each of the battery packages including a first battery cell and a second battery cell, an expansion unit disposed between the first battery cell and the second battery cell, and a frame assembly including a frame body and a pair of frame covers, the frame body having a first recess, a second recess, and a central aperture disposed between the first recess and the second recess, the first recess receiving the first battery cell, the second recess receiving the second battery cell, and the central aperture receiving the expansion unit, each of the frame covers disposed adjacent one of the first recess and the second recess to hold the first battery cell, the second battery cell, and the expansion unit within the frame body; and
a heat exchanger having a plurality of cooling fins, at least one of the cooling fins disposed between a pair of the plurality of battery packages.

19. A method for manufacturing a battery pack assembly, the method comprising the steps of:
stacking a plurality of battery packages, each of the battery packages including a first battery cell and a second battery cell, an expansion unit disposed between the first battery cell and the second battery cell, and a frame assembly including a frame body and a pair of frame covers, the frame body having a first recess, a second recess, and a central aperture disposed between the first recess and the second recess, the first recess receiving the first battery cell, the second recess receiving the second battery cell, and the central aperture receiving the expansion unit, each of the frame covers disposed adjacent one of the first recess and the second recess to hold the first battery cell, the second battery cell, and the expansion unit within the frame body; and
inserting the plurality of battery packages into a heat exchanger having a plurality of cooling fins, wherein at least one of the cooling fins is disposed between a pair of the plurality of battery packages.

20. The method of claim 19, wherein the frame covers protect outside surfaces of the first and second battery cells and hold the first and second battery cells and the expansion unit in position in a vertical and a lateral direction, and allow a movement of the first and the second battery cells and the expansion unit in a stacking direction.
